(19) United States
(12) Patent Application Publication
(10) Pub. No.: US 2023/0393558 A1
(43) Pub. Date: Dec. 7, 2023

(54) CONTROL METHOD FOR CONSENSUS OF AGRICULTURAL MULTI-AGENT SYSTEM BASED ON SAMPLED DATA

(71) Applicant: Qilu University of Technology, Jinan (CN)

(72) Inventors: Fengying MA, Jinan (CN); Hui YAO, Jinan (CN); Mingjun DU, Jinan (CN); Peng JI, Jinan (CN)

(21) Appl. No.: 18/316,345

(22) Filed: May 12, 2023

(30) Foreign Application Priority Data
Jun. 6, 2022 (CN) 202210626977.9

(51) Int. Cl. G05B 19/4155

(52) U.S. Cl. CPC G05B 19/4155; G05B 2219/45017

(57) ABSTRACT

The present invention relates to the field of control engineering, in particular to a distributed control method for consensus of an agricultural multi-agent system based on sampled data, comprising the following steps: for a first-order multi-agent system with fixed directed topology, designing a distributed control protocol based on sampled information in a time delay state; obtaining a dynamic model of the multi-agent system with time delays based on sampled information, and transforming a consensus problem of multiple agents into a stability problem by means of tree transformation; determining constraint conditions on a time delay and a sampling period that the multi-agent system achieves stability, that is, sufficient and necessary conditions that the agents in the multi-agent system achieve average state consensus; and realizing average consensus of the multi-agent system according to the sufficient and necessary conditions.

### CROSS REFERENCE TO RELATED APPLICATIONS

This application claims foreign priority of Chinese Patent Application No. 202210626977.9, filed on Jun. 6, 2022 in the China National Intellectual Property Administration, the disclosures of all of which are hereby incorporated by reference.

### BACKGROUND OF THE INVENTION

### 1. Technical Field

The present invention relates to the field of control engineering, in particular to a distributed control method for consensus of an agricultural multi-agent system based on sampled data.

### 2. Description of Related Art

Driven by digital revolution, agriculture has gradually begun to move towards intelligence, and intelligent agriculture is an important development direction of agriculture in the digital age. The intelligent agriculture, which integrates theoretical knowledge of mathematics, automation, computer, information communication and agriculture and applies same to agricultural agents of hardware, has received extensive attention from scholars of related disciplines such as information technology, computer science and agricultural science.

The planting methods of different crops are greatly different, but need a lot of labor, particularly in the aspects of planting, spraying, picking, etc. of crops. Even during farming, the use of chemical pesticides or frequent repetitive actions in a short time may produce a certain impact on the health of workers. Therefore, the level of agricultural mechanization needs to be further improved, and the emergence of multi-agent systems provides a new development trend for reducing labor and improving the level of agricultural mechanization.

A multi-agent system refers to a group system composed of a plurality of independent individuals, and its goal is communication and interaction through mutual information among the individuals. An agent refers to an autonomous individual with the basic characteristics of autonomy, sociality, response and pre-activity, and may be regarded as a corresponding software program or an entity (such as a person, a vehicle, or a robot). Among many researches on multi-agent systems, the consensus problem is one of the most valuable topics. For agricultural multi-agent systems, the consensus problem is more important. In traditional multi-agent system consensus control protocols, a lot of information interaction is required to achieve a state consensus, and the multi-agent systems are required to be equipped with high-performance processors, which improve the design and manufacturing costs of agricultural multi-agent systems.

### BRIEF SUMMARY OF THE INVENTION

In order to reduce redundant information interaction and reduce requirements for processor configuration, a distributed control protocol based on sampled data was introduced into the research on the consensus problem of an agricultural multi-agent system. Different from other continuous control protocols, the control protocol based on sampled data reduces information redundancy, reduces the control cost of a system and the requirements of network communication, and improves the robustness and redundancy of the system. Meanwhile, in order to make the control protocol more practical and achieve average state consensus among agents in the case of time delay, the distributed control protocol based on sampled data was considered in the presence of time delay.

The present invention provides the following technical solution: a distributed control method for consensus of an agricultural multi-agent system based on sampled data, including the following steps:
Step 1, for a first-order multi-agent system with fixed directed topology, designing a distributed control protocol based on sampled information in a time delay state;
Step 2, obtaining a dynamic model of the multi-agent system with time delays based on sampled information, and transforming a consensus problem of multiple agents into a stability problem by means of tree transformation;
Step 3, determining constraint conditions on a time delay and a sampling period that the multi-agent system achieves stability, that is, sufficient and necessary conditions that the agents in the multi-agent system achieve average state consensus; and
Step 4, realizing average consensus of the multi-agent system according to the sufficient and necessary conditions that the multi-agent system achieves average consensus.

In step 1, for a system including N agents, the states of the agents are represented by xᵢ, where i=1, 2, . . . , N; the communication topology directed graph G=(V, E, A) of the networked multi-agent system is a weighted directed graph, N vertices v in the directed graph G represent N agents in the multi-agent system, and the i-th vertex of the directed graph G is represented by vᵢ, where i=1, 2, . . . , N; V={v₁, v₂, . . . , v_{N}} represents a set of vertices, and the vertex vᵢ is the i-th vertex in the directed graph G and corresponds to the i-th agent in the multi-agent system; there are totally N vertices, each agent is a vertex of the directed graph G, and the state level of each vertex represents an actual physical value, including position, temperature, or voltage; E⊆V×V is a frontier set, and A=[aᵢⱼ] is a non-negative weighted adjacency matrix, where j=1, 2, . . . , N; a directed edge from the vertex vᵢ to vⱼ is Eᵢⱼ=(vⱼ, vᵢ), an adjacency matrix element aᵢⱼ with regard to Eᵢⱼ is a non-negative real number, and a set of neighborhood nodes of the vertex vᵢ is Nᵢ={vᵢ∈V|(vⱼ,vᵢ)∈E}; if there is at least one directed edge between two vertices, the directed graph G is a strongly connected graph, and the directed graph G has an indegree matrix

$$Δ = diag \{ {\sum }_{j = 1}^{n} {a}_{1 j} , {\sum }_{j = 1}^{n} {a}_{2 j} , … , {\sum }_{j = 1}^{n} {a}_{nf} \}$$

and a Laplacian matrix L=[lᵢⱼ]∈R^{n×n}, where L=Δ−A.

An element lᵢⱼ in the Laplacian matrix satisfies

$${l}_{ij} = \{ \begin{matrix}{\sum }_{j ∈ N ( i )} {a}_{ij} , j = i \\ - {a}_{ij} , j \neq i\end{matrix} .$$

Because the agricultural multi-agent system studied is strongly connected, a diagonal matrix W=diag{det(L₁₁), det(L₂₂), . . . , det(Lₙₙ)} may be derived, a left eigenvector being wᵢ=[det(L₁₁), det(L₂₂), . . . , det(Lₙₙ)], where ω^{T}L=0ₙ^{T}, Lᵢᵢ∈R^{(n-1)×(n-1)} is a matrix after the i-th row and the i-column are removed from the Laplacian matrix, where det(Lᵢᵢ) represents a determinant of the matrix Lᵢᵢ; a new topology graph G̅=(V, Ē, Ā) may be obtained according to the diagonal matrix W, where an element āᵢⱼ in Ā=[āᵢⱼ] satisfies the following:

$${\overline{a}}_{ij} = \frac{det ( {L}_{ii} ) {a}_{ij} + det ( {L}_{jj} ) {a}_{ji}}{2} , ∀ i , j ∈ {ℐ}_{n} .$$

Where, [symbol] ₙ={1, 2, . . . , N}, the following may be further obtained:

$$\overline{A} = \frac{WA + {A}^{T} W}{2} .$$

The relationship between the Laplacian matrix L of the topology graph G and the Laplacian matrix L̅ of the topology graph G̅ is as follows:

$$\overline{L} = \frac{WL + {L}^{T} W}{2} .$$

In addition, all other eigenvalues λ₂, . . . , λₙ of the Laplacian matrix L except a zero eigenvalue λ₁ have a positive real part, and the mirror graph G̅ of the directed graph G satisfies the properties of an undirected strongly connected graph.

Considering the average consensus problem of the multi-agent system with strongly connected directed topology, the relationship between agents is represented by an edge relationship between vertices. In the directed graph G of the multi-agent system, the state of each vertex vᵢ is represented by xᵢ, a state vector of vertices is represented by x(t), x(t)=[x₁(t), x₂(t), . . . , xₙ(t)]^{T}∈Rⁿ, and the dynamic model of the first-order multi-agent system with fixed directed topology is represented as follows:

\dot{x}ᵢ(t)=uᵢ(t),∀i∈ [symbol] ₙ.

uᵢ(t) is a control input used for solving the consensus problem.

In order to reduce the communication cost of the intelligent agricultural multi-agent system, the objective of the present invention is to solve average consensus problem of the agricultural multi-agent system by using sampled data. In practical applications of the agricultural multi-agent system, the consensus may also be affected by a communication delay. Especially in crop planting, multiple agents need to transmit information to each other in the process of completing a planting task, and excessive communication delay may lead to oscillation or divergence of the multi-agent system, so the problem of time delay needs to be considered. For the communication delay of the agricultural multi-agent system, the sampling period is set as p. Considering the existence of a time delay τ shorter than one sampling period, the proposed distributed delay control protocol based on sampled data is as follows:

$${u}_{i} ( t ) = \{ \begin{matrix}{\sum }_{j ∈ N ( i )} {\overline{a}}_{ij} ( {x}_{j} ( kp - p ) - {x}_{i} ( kp - p ) ) , t ∈ [ kp , kp + τ ] \\ {\sum }_{j ∈ N ( i )} {\overline{a}}_{ij} ( {x}_{j} ( kp ) - {x}_{i} ( kp ) ) , t ∈ [ kp + τ , kp + p ]\end{matrix} .$$

∀i∈ [symbol] ,k=0,1,2, . . . ,0<τ<p.

In step 2, the specific process of obtaining a dynamic model of the multi-agent system with time delays by means of the distributed control protocol based on sampled data, and transforming a consensus problem of multiple agents into a stability problem by means of tree transformation includes:
obtaining, according to the proposed distributed delay control protocol, the dynamic model of the first-order multi-agent system at the sampling period p and time delay τ:

$$[ \begin{matrix}x ( kp + p ) \\ x ( kp )\end{matrix} ] = ϕ [ \begin{matrix}x ( kp ) \\ x ( kp - p )\end{matrix} ] , k = 0 , 1 , 2 , …$$

$$Where ϕ = [ \begin{matrix}{I}_{n} - ( p - τ ) \overline{L} & - τ \overline{L} \\ {I}_{n} & 0\end{matrix} ] ,$$

Where I is a unit matrix, and Iₙ is an n-order unit matrix.

In order to analyze a convergence problem of the system after the protocol is used, the dynamic model is transformed by means of tree transformation:

$${y}_{1} ( kp ) = {x}_{1} ( kp )$$

$${y}_{2} ( kp ) = {x}_{1} ( kp ) - {x}_{2} ( kp )$$

$${y}_{3} ( kp ) = {x}_{1} ( kp ) - {x}_{3} ( kp )$$

$$□$$

$${y}_{n} ( kp ) = {x}_{1} ( kp ) - {x}_{n} ( kp ) ;$$

An invertible matrix Q is obtained:

$$Q = [ \begin{matrix}1 & 0 & 0 & … & 0 \\ 1 & - 1 & 0 & … & 0 \\ 1 & 0 & - 1 & … & 0 \\ ⋮ & ⋮ & ⋮ & ⋱ & ⋮ \\ 1 & 0 & 0 & … & - 1\end{matrix} ] = [ \begin{matrix}C ∈ {R}^{1 \times n} \\ E ∈ {R}^{( n - 1 ) \times n}\end{matrix} ]$$

Q⁻¹ is obtained:

$${Q}^{- 1} = [ \begin{matrix}1 & 0 & 0 & … & 0 \\ 1 & - 1 & 0 & … & 0 \\ 1 & 0 & - 1 & … & 0 \\ ⋮ & ⋮ & ⋮ & ⋱ & ⋮ \\ 1 & 0 & 0 & … & - 1\end{matrix} ] = \text{?}$$

$$\text{?} \text{indicates text missing or illegible when filed}$$

The following is obtained from Q and Q⁻¹:

$$y ( kp ) {=}^{Δ} [ \begin{matrix}{y}_{1} ( kp ) \\ {y}_{2} ( kp ) \\ ⋮ \\ {y}_{n} ( kp )\end{matrix} ] = Qx ( kp ) .$$

Thus, y(kp+p)=Qx(kp+p), y(kp−p)=Qx(kp−p) and y(kp)=Qx(kp) are obtained, and the following is further obtained:

$$[ \begin{matrix}y ( kp + p ) \\ y ( kp )\end{matrix} ] = [ \begin{matrix}{I}_{n} - ( p - τ ) H & - τ H \\ {I}_{n} & {0}_{n}\end{matrix} ] [ \begin{matrix}y ( kp ) \\ y ( kp - p )\end{matrix} ] ,$$

$$Where H = Q \overline{L} {Q}^{- 1} = [ \begin{matrix}0 & C \overline{L} F \\ {0}_{n - 1} & E \overline{L} F\end{matrix} ] ;$$

Thus, the system is divided into two subsystems:

$$[ \begin{matrix}{y}_{1} ( kp + p ) \\ {y}_{1} ( kp )\end{matrix} ] = [ \begin{matrix}1 & 0 \\ 1 & 0\end{matrix} ] [ \begin{matrix}{y}_{1} ( kp ) \\ {y}_{1} ( kp - p )\end{matrix} ] - [ \begin{matrix}( p - τ ) C \overline{L} F & τ C \overline{L} F \\ 0 & 0\end{matrix} ] [ \begin{matrix}\hat{y} ( kp ) \\ \hat{y} ( kp - p )\end{matrix} ]$$

$$and$$

$$[ \begin{matrix}{y}_{1} ( kp + p ) \\ {y}_{1} ( kp )\end{matrix} ] = [ \begin{matrix}{I}_{n - 1} - ( p - τ ) E \overline{L} F & - τ E \overline{L} F \\ {I}_{n - 1} & {0}_{n - 1}\end{matrix} ] [ \begin{matrix}\hat{y} ( kp + p ) \\ \hat{y} ( kp - p )\end{matrix} ] .$$

$$Where ,$$

$$\hat{y} ( kp ) = {[ {y}_{2} ( kp ) , {y}_{3} ( kp ) , … , {y}_{n} ( kp ) ]}^{T} and$$

$$\hat{y} ( kp - p ) = {[ {y}_{2} ( kp - p ) , {y}_{3} ( kp - p ) , … , {y}_{n} ( kp - p ) ]}^{T} .$$

As can be seen, the subsystems after dimension reduction achieve stability, indicating that the whole system achieves consensus.

In step 3, the constraint conditions on the time delay and the sampling period that the multi-agent system achieves stability, that is, the sufficient and necessary conditions that the agents in the multi-agent system achieve average state consensus, are obtained by means of bilinearity and Hurwitz stability criteria, specifically:

The following is obtained by using an invertible matrix T:

$${T}^{- 1} E \overline{L} FT = Λ = [ \begin{matrix}{λ}_{2} & * & & \\ & {λ}_{3} & ⋱ & \\ & & ⋱ & * \\ & & & {λ}_{n}\end{matrix} ]$$

Where λ₂, λ₃, . . . , λₙ are non-zero eigenvalues of L̅ and elements, * is 0 or 1, and further,

\tilde{y}(kp+p)=T⁻¹ŷ(kp+p).

\tilde{y}(kp)=T⁻¹ŷ(kp)

\tilde{y}(kp−p)=T⁻¹ŷ(kp−p).

The dimension reduction system is transformed into:

$$[ \begin{matrix}\tilde{y} ( kp + p ) \\ \tilde{y} ( kp )\end{matrix} ] = ζ [ \begin{matrix}\tilde{y} ( kp + p ) \\ \tilde{y} ( kp - p )\end{matrix} ] ,$$

$$Where$$

$$ζ [ \begin{matrix}{I}_{n - 1} - ( p - τ ) Λ & - τΛ \\ {I}_{n - 1} & {0}_{n - 1}\end{matrix} ] .$$

A characteristic polynomial of is further obtained:

$$det ( {sI}_{2 n - 2} - ζ ) = \vert \begin{matrix}{sI}_{n - 1} - [ {I}_{n - 1} - ( p - τ ) Λ ] & τΛ \\ - {I}_{n - 1} & {sI}_{n - 1}\end{matrix} \vert = \vert ξ \vert .$$

The following is obtained from the properties of a block matrix:

$$\vert ξ \vert = \vert {sI}_{n - 1} \vert \vert {sI}_{n - 1} - [ {I}_{n - 1} - ( p - τ ) Λ ] + {{I}_{n - 1} ( {sI}_{n - 1} )}^{- 1} τΛ \vert = {\prod }_{i = 2}^{n} [ {s}^{2} - ( 1 - p {λ}_{1} + {τλ}_{1} ) s + {τλ}_{1} ] = {\prod }_{i = 2}^{n} {g}_{i} ( s ) .$$

Then, the following can be known by bilinear transformation of

$$s = \frac{z + 1}{z - 1} :$$

fᵢ(z)=pλᵢz²+2(1−τλᵢ)z+(p−2τ)λᵢ+2.

If fᵢ(z) is Hurwitz-stable and gᵢ(s) is Schur-stable, the stability is determined as follows:

Assuming z=ωι, then:

fᵢ(ω)=−pλᵢω²+2(1−τλᵢ)ωι+(p−2τ)λᵢ+2,

Its real part is:

f_{ω}(ω)=−pλᵢω²+(p−2τ)λᵢ+2 and

Its imaginary part is:

fᵢ(ω)=2(1−τλᵢ)ω;

Upon verification, fᵢ(z) is Hurwitz-stable when satisfying the following conditions:

$$τ < \frac{1}{{λ}_{max}} , 0 < p < \frac{2}{{λ}_{max}} + 2 τ ,$$

That is, under the Hurwitz-stable condition, the multi-agent system achieves consensus.

Step 4 includes the following steps: because L̅ has an eigenvalue of 0, ϕ has corresponding determinable eigenvalues of 0 and 1; the condition of Hurwitz stability of the system is determined after the tree transformation; when the constraint conditions are satisfied, the modulus values of remaining unknown eigenvalues of ϕ are less than 1, that is, the eigenvalues of ϕ except 0 and 1 are within a unit circle under the conditions; because G̅ has undirected strongly connected, so a right eigenvector ωᵣ and a left eigenvector ωₗ of ϕ when the eigenvalue is 1 satisfy the following:

$${w}_{r} = {w}_{l} = \frac{1}{\sqrt{n}} {1}_{n} ,$$

and ωₗ^{T} ωᵣ=1 is satisfied;

All other eigenvalues of ϕ are within the unit circle and there is:

$$[ \begin{matrix}x ( kp + p ) \\ x ( kp )\end{matrix} ] = ϕ [ \begin{matrix}x ( kp ) \\ x ( kp - p )\end{matrix} ] = {ϕ}^{x} [ \begin{matrix}x ( 0 ) \\ x ( 0 )\end{matrix} ] ,$$

$$So :$$

$${lim}_{k \to ∞} [ \begin{matrix}x ( kp + p ) \\ x ( kp )\end{matrix} ] = \text{?} [ \begin{matrix}x ( 0 ) \\ x ( 0 )\end{matrix} ] = \text{?}$$

$$\text{?} \text{indicates text missing or illegible when filed}$$

Therefore, through the control protocol based on sampled information proposed by the present invention, the agricultural multi-agent system with a first-order dynamic model can also achieve average consensus despite a time delay.

It can be seen from the above description that the average consensus distributed control protocol for the agricultural multi-agent system with time delays based on sampled data in the present invention considers the influence of the time continuous control protocol and time delay on the performance of the multi-agent system. The control protocol is designed by a sampling means and a sampling period, thus obtaining an upper limit of sampling period to achieve average consensus of the system. Compared with a continuous control protocol, the robustness and information utilization of the multi-agent system are improved, and the requirements for system hardware are reduced. The control protocol proposed by the present invention overcomes the influence of time delay on the average consensus. With the help of analysis methods of graph theory and matrix theory, sufficient and necessary conditions that the agricultural multi-agent system achieves average consensus are given, and a sampling period and upper and lower limits of upper and lower limits of a time delay are obtained. Because the protocol in the present invention can enable the multi-agent system to achieve the average consensus, the state value for finally achieving the average consensus can be further adjusted by setting the initial state value of each agent in the agricultural system.

### BRIEF DESCRIPTION OF THE SEVERAL VIEWS OF THE DRAWINGS

FIG. 1 is a flowchart of the present invention.

FIG. 2 is a communication topology diagram of a multi-agent system in a specific embodiment.

FIG. 3 shows a convergence state of each agent when the time delay τ=0.2 and the sampling period p=0.93 in the specific embodiment.

FIG. 4 shows a convergence state of each agent when the time delay τ=0.2616 and the sampling period p=1.04 in the specific embodiment.

FIG. 5 shows a convergence state of each agent when the time delay τ=0.2 and the sampling period p=0.92 in the specific embodiment.

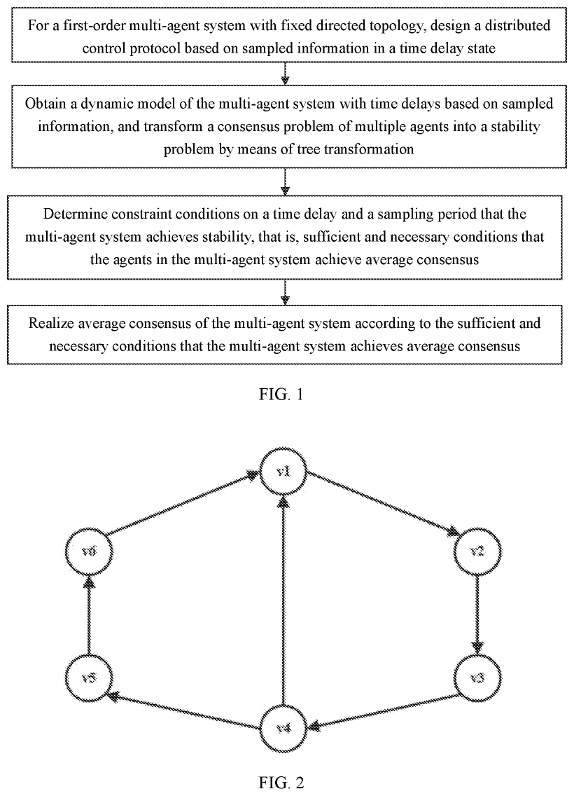

### DETAILED DESCRIPTION OF THE INVENTION

Technical solutions in specific embodiments of the present invention will be clearly and completely described below with reference to the accompanying drawings in the specific embodiments of the present invention. Apparently, the specific embodiments described are only some of the specific embodiments of the present invention, not all of them. Based on the specific embodiments in the present invention, all other specific embodiments obtained by those of ordinary skill in the art without any creative effort fall within the protection scope of the present invention.

As can be seen from the accompanying drawings, a distributed control method for consensus of an agricultural multi-agent system based on sampled data in the present invention includes the following four steps.

Step 1, for a first-order multi-agent system with fixed directed topology, a distributed control protocol based on sampled information in a time delay state is designed.

In this step, for a system including N agents, the states of the agents are represented by xᵢ, where i=1, 2, . . . , N; the communication topology directed graph G=(V, E, A) of the networked multi-agent system is a weighted directed graph, N vertices v in the directed graph G represent N agents in the multi-agent system, and the i-th vertex of the directed graph G is represented by vᵢ, where i=1, 2, . . . , N; V={v₁, v₂, . . . , v_{N}} represents a set of vertices, and the vertex vᵢ is the i-th vertex in the directed graph G and corresponds to the i-th agent in the multi-agent system; there are totally N vertices, each agent is a vertex of the directed graph G, and the state level of each vertex represents an actual physical value, including position, temperature, or voltage; E⊆V×V is a frontier set, and A=[αᵢⱼ] is a non-negative weighted adjacency matrix, where j=1, 2, . . . , N; a directed edge from the vertex vᵢ to vⱼ is Eᵢⱼ=(vⱼ, vᵢ), an adjacency matrix element αᵢⱼ with regard to Eᵢⱼ is a non-negative real number, and a set of neighborhood nodes of the vertex vᵢ is Nᵢ={vᵢ∈V|(vⱼ,vᵢ)∈E}; if there is at least one directed edge between two vertices, the directed graph G is a strongly connected graph, and the directed graph G has an indegree matrix

$$Δ = diag \{ {\sum }_{j = 1}^{n} {a}_{1 j} , {\sum }_{j = 1}^{n} {a}_{2 j} , … , {\sum }_{j = 1}^{n} {a}_{nj} \}$$

and a Laplacian matrix L=[lᵢⱼ]∈R^{n×n}, where L=Δ−A.

An element lᵢⱼ in the Laplacian matrix satisfies

$${I}_{ij} = \{ \begin{matrix}{\sum }_{j ∈ N ( i )} {a}_{ij} , j = i \\ - {a}_{ij} , j \neq i\end{matrix} .$$

Because the agricultural multi-agent system studied is strongly connected, a diagonal matrix W=diag{det(L₁₁), det(L₂₂), . . . , det(Lₙₙ)} may be derived, a left eigenvector being wᵢ=[det(L₁₁), det(L₂₂) . . . , det(Lₙₙ)], where ω^{T} L=0ₙ^{T}; Lᵢᵢ∈R^{(n-1)×(n-1)} is a matrix after the i-th row and the i-column are removed from the Laplacian matrix, where det(Lᵢᵢ) represents a determinant of the matrix Lᵢᵢ; a new topology graph G̅=(V, Ē, Ā) may be obtained according to the diagonal matrix W, where an element in āᵢⱼ in Ā=[āᵢⱼ] satisfies the following:

$${\overline{a}}_{ij} = \frac{det ( {L}_{ii} ) {a}_{ij} + det ( {L}_{jj} ) {a}_{ji}}{2} , ∀ i , j ∈ {ℐ}_{n}$$

Where [symbol] ₙ={1, 2, . . . , N}, the following may be further obtained:

$$\overline{A} = \frac{WA + {A}^{T} W}{2} .$$

The relationship between the Laplacian matrix L of the topology graph G and the Laplacian matrix L̅ of the topology graph G̅ is as follows:

$$\overline{L} = \frac{WA + {L}^{T} W}{2} .$$

In addition, all other eigenvalues λ₂, . . . , λₙ of the Laplacian matrix L̅ except a zero eigenvalue λ₁ have a positive real part, and the mirror graph G̅ of the directed graph G satisfies the properties of an undirected strongly connected graph.

Considering the average consensus problem of the multi-agent system with strongly connected directed topology, the relationship between agents is represented by an edge relationship between vertices. In the directed graph G of the multi-agent system, the state of each vertex vᵢ is represented by xᵢ, a state vector of vertices is represented by x(t), x(t)=[x₁(t), x₂(t), . . . , xₙ(t)]^{T}∈Rⁿ, and a dynamic model of the first-order multi-agent system with fixed directed topology is represented as follows:

\dot{x}ᵢ(t)=uᵢ(t),∀i∈ [symbol] ₙ.

uᵢ(t) is a control input used for solving the consensus problem.

In order to reduce the communication cost of the intelligent agricultural multi-agent system, the objective of the present invention is to solve average consensus problem of the agricultural multi-agent system by using sampled data. In practical applications of the agricultural multi-agent system, the consensus may also be affected by a communication delay. Especially in crop planting, multiple agents need to transmit information to each other in the process of completing a planting task, and excessive communication delay may lead to oscillation or divergence of the multi-agent system, so the problem of time delay needs to be considered. For the communication delay of the agricultural multi-agent system, a sampling period is set as p. Considering the existence of a time delay τ shorter than one sampling period, the proposed distributed delay control protocol based on sampled data is as follows:

$${u}_{i} ( t ) = \{ \begin{matrix}{\sum }_{j ∈ N ( i )} {\overline{a}}_{ij} ( {x}_{j} ( kp - p ) - {x}_{i} ( kp - p ) ) , & t ∈ [ kp , kp + τ ] \\ {\sum }_{j ∈ N ( i )} {\overline{a}}_{ij} ( {x}_{j} ( kp ) - {x}_{i} ( kp ) ) , & t ∈ [ kp + τ , kp + p ]\end{matrix}$$

$$∀ i ∈ {ℐ}_{n} , k = 0 , 1 , 2 , … , 0 < τ < p .$$

Step 2, a dynamic model of the multi-agent system with time delays based on sampled information is obtained, and a consensus problem of multiple agents is transformed into a stability problem by means of tree transformation.

In step 2, the specific process of obtaining a dynamic model of the multi-agent system with time delays by means of the distributed control protocol based on sampled data, and transforming a consensus problem of multiple agents into a stability problem by means of tree transformation includes:

According to the proposed distributed delay control protocol, the dynamic model of the first-order multi-agent system at the sampling period p and time delay τ is obtained:

$$[ \begin{matrix}x ( kp + p ) \\ x ( kp )\end{matrix} ] = ϕ [ \begin{matrix}x ( kp ) \\ x ( kp - p )\end{matrix} ] , k = 0 , 1 , 2 , …$$

$$Where ϕ = [ \begin{matrix}{I}_{n} - ( p - τ ) \overline{L} & - τ \overline{L} \\ {I}_{n} & 0\end{matrix} ] .$$

Where I is a unit matrix, and Iₙ is an n-order unit matrix.

In order to analyze a convergence problem of the system after the protocol is used, the dynamic model is transformed by means of tree transformation:

y₁(kp)=x₁(kp)

y₂(kp)=x₁(kp)−x₂(kp)

y₃(kp)=x₁(kp)−x₃(kp)

□

yₙ(kp)=x₁(kp)−xₙ(kp)

An invertible matrix Q is obtained:

$$Q = [ \begin{matrix}1 & 0 & 0 & … & 0 \\ 1 & - 1 & 0 & … & 0 \\ 1 & 0 & - 1 & … & 0 \\ ⋮ & ⋮ & ⋮ & ⋱ & ⋮ \\ 1 & 0 & 0 & … & - 1\end{matrix} ] = [ \begin{matrix}C ∈ {R}^{1 \times n} \\ E ∈ {R}^{( n - 1 ) \times n}\end{matrix} ]$$

Q⁻¹ is obtained:

$${Q}^{- 1} = [ \begin{matrix}1 & 0 & 0 & … & 0 \\ 1 & - 1 & 0 & … & 0 \\ 1 & 0 & - 1 & … & 0 \\ ⋮ & ⋮ & ⋮ & ⋱ & ⋮ \\ 1 & 0 & 0 & … & - 1\end{matrix} ] = [ {w}_{r} ∈ {R}^{n \times 1} F ∈ {R}^{n \times ( n - 1 )} ]$$

The following is obtained from Q and Q⁻¹:

$$y ( kp ) {=}^{Δ} [ \begin{matrix}{y}_{1} ( p ) \\ {y}_{2} ( kp ) \\ ⋮ \\ {y}_{ii} ( kp )\end{matrix} ] = Qx ( kp ) .$$

Thus, y(kp+p)=Qx(kp+p), y(kp−p)=Qx(kp−p) and y(kp)=Qx(kp) are obtained, and the following is further obtained:

$$[ \begin{matrix}y ( kp + p ) \\ y ( kp )\end{matrix} ] = [ \begin{matrix}{I}_{n} - ( p - τ ) H & - τ H \\ {I}_{n} & {0}_{n}\end{matrix} ] [ \begin{matrix}y ( kp ) \\ y ( kp - p )\end{matrix} ] ,$$

$$Where H = Q \overline{L} {Q}^{- 1} [ \begin{matrix}0 & C \overline{L} F \\ {0}_{n - 1} & E \overline{L} F\end{matrix} ] ;$$

Thus, the system is divided into two subsystems:

$$[ \begin{matrix}y ( kp + p ) \\ y ( kp )\end{matrix} ] = [ \begin{matrix}1 & 0 \\ 1 & 0\end{matrix} ] [ \begin{matrix}{y}_{1} ( kp ) \\ {y}_{1} ( kp - p )\end{matrix} ] - [ \begin{matrix}( p - τ ) C \overline{L} F & τC \overline{L} F \\ 0 & 0\end{matrix} ] [ \begin{matrix}\hat{y} ( kp ) \\ \hat{y} ( kp - p )\end{matrix} ]$$

$$and [ \begin{matrix}{y}_{1} ( kp + p ) \\ {y}_{1} ( kp )\end{matrix} ] = [ \begin{matrix}{I}_{n - 1} - ( p - τ ) E \overline{L} F & - τ E \overline{L} F \\ {I}_{n - 1} & {0}_{n - 1}\end{matrix} ] [ \begin{matrix}\hat{y} ( kp ) \\ \hat{y} ( kp - p )\end{matrix} ] .$$

Where,

ŷ(kp)=[y₂(kp),y₃(kp), . . . ,yₙ(kp)]^{T} and

ŷ(kp−p)=[y₂(kp−p),y₃(kp−p), . . . ,yₙ(kp−p)]^{T}.

As can be seen, the subsystems after dimension reduction achieve stability, indicating that the whole system achieves consensus.

Step 3, constraint conditions on a time delay and a sampling period that the multi-agent system achieves stability, that is, sufficient and necessary conditions that the agents in the multi-agent system achieve average state consensus, are determined.

In step 3, the constraint conditions on the time delay and the sampling period that the multi-agent system achieves stability, that is, the sufficient and necessary conditions that the agents in the multi-agent system achieve average state consensus, are obtained by means of bilinearity and Hurwitz stability criteria, specifically:

The following is obtained by using an invertible matrix T:

$${T}^{- 1} E \overline{L} FT = Λ = [ \begin{matrix}{λ}_{2} & * & & \\ & {λ}_{3} & ⋱ & \\ & & ⋱ & * \\ & & & {λ}_{n}\end{matrix} ]$$

Where λ₂, λ₃, . . . , λₙ are non-zero eigenvalues of L̅ and elements, * is 0 or 1, and further,

\tilde{y}(kp+p)=T⁻¹ŷ(kp+p)

\tilde{y}(kp)=T⁻¹ŷ(kp)

\tilde{y}(kp−p)=T⁻¹ŷ(kp−p).

The dimension reduction system is transformed into:

$$[ \begin{matrix}\tilde{y} ( kp + p ) \\ \tilde{y} ( kp )\end{matrix} ] = ζ [ \begin{matrix}\tilde{y} ( kp + p ) \\ \tilde{y} ( kp - p )\end{matrix} ] ,$$

$$Where ζ = [ \begin{matrix}{I}_{n - 1} - ( p - τ ) Λ & - τ Λ \\ {I}_{n - 1} & {0}_{n - 1}\end{matrix} ] .$$

A characteristic polynomial of is further obtained:

$$det ( {sI}_{2 n - 2} - ζ ) = \vert \begin{matrix}{sI}_{n - 1} - [ {I}_{n - 1} - ( p - τ ) Λ ] & τΛ \\ - {I}_{n - 1} & {sI}_{n - 1}\end{matrix} \vert = \vert ξ \vert .$$

The following is obtained from the properties of a block matrix:

$$\begin{matrix}\vert ξ \vert = \vert {sI}_{n - 1} \vert \vert {sI}_{n - 1} - [ {I}_{n - 1} - ( p - τ ) Λ ] + {{I}_{n - 1} ( {sI}_{n - 1} )}^{- 1} τΛ \vert \\ = {\prod }_{i = 1}^{n} [ {s}^{2} - ( 1 - p {λ}_{l} + τ {λ}_{l} ) s + λ {Λ}_{l} ) \\ = {\prod }_{i = 2}^{n} {g}_{i} ( s ) .\end{matrix}$$

Then, the following can be known by bilinear transformation of

$$s = \frac{z + 1}{z - 1} :$$

fᵢ(z)=pλᵢz²+2(1−τλᵢ)z+(p−2τ)λᵢ+2.

If fᵢ(z) is Hurwitz-stable and gᵢ(s) is Schur-stable, the stability is determined as follows:

Assuming z=ωι, then:

fᵢ(ω)=−pλᵢω²+2(1−τλᵢ)ωι+(p−2τ)λᵢ+2,

Its real part is:

f_{ω}(ω)=−pλᵢω²+(p−2τ)λᵢ+2 and

Its imaginary part is:

fᵢ(ω)=2(1−τλᵢ)ω;

Upon verification, fᵢ(z) is Hurwitz-stable when satisfying the following conditions:

$$τ < \frac{1}{{λ}_{max}} , 0 < p < \frac{2}{{λ}_{max}} + 2 τ ,$$

That is, under the Hurwitz-stable condition, the multi-agent system achieves consensus.

Step 4, average consensus of the multi-agent system is realized according to the sufficient and necessary conditions that the multi-agent system achieves average consensus.

Step 4 includes the following steps: because L̅ has an eigenvalue of 0, ϕ has corresponding determinable eigenvalues of 0 and 1; the condition of Hurwitz stability of the system is determined after the tree transformation; when the constraint conditions are satisfied, the modulus values of remaining unknown eigenvalues of ϕ are less than 1, that is, the eigenvalues of ϕ except 0 and 1 are within a unit circle under the conditions; because G̅ is undirected strongly connected, so a right eigenvector ωᵣ and a left eigenvector ωₗ of ϕ when the eigenvalue is 1 satisfy the following:

$${w}_{r} = {w}_{l} = \frac{1}{\sqrt{n}} {1}_{n} ,$$

and ωₗ^{T} ωᵣ=1 is satisfied;

All other eigenvalues of ϕ are within the unit circle and there is:

$$[ \begin{matrix}x ( kp + p ) \\ x ( kp )\end{matrix} ] = ϕ [ \begin{matrix}x ( kp ) \\ x ( kp - p )\end{matrix} ] = {ϕ}^{k} [ \begin{matrix}x ( 0 ) \\ x ( 0 )\end{matrix} ] ,$$

$$So : {lim}_{k \to ∞} [ \begin{matrix}x ( kp + p ) \\ x ( kp )\end{matrix} ] = [ \begin{matrix}{w}_{r} {w}_{l}^{T} & 0 \\ {w}_{r} {w}_{l}^{T} & 0\end{matrix} ] [ \begin{matrix}x ( 0 ) \\ x ( 0 )\end{matrix} ] = [ \begin{matrix}\frac{1}{n} {\sum }_{i = 1}^{n} {x}_{i} ( 0 ) \\ \frac{1}{n} {\sum }_{i = 1}^{n} {x}_{i} ( 0 )\end{matrix} ] .$$

Therefore, through the control protocol based on sampled information proposed by the present invention, the agricultural multi-agent system with a first-order dynamic model can also achieve average consensus despite a time delay.

When this method is implemented, the communication topology of the agricultural first-order multi-agent system including six agents is represented by G₁, and the states of the six agents are represented by xᵢ, x₂, x₃, x₄, x₅, and x₆. It can be seen that the graph G₁ is directed unbalanced, and the weight of edges is 1, where V={v₁, v₂, v₃, v₄, v₅, v₆}, and x=[x₁, x₂, x₃, x₄, x₅, x₆]^{T}. The communication topology is shown in FIG. 2.

Parameters of the system are as follows:

$$A = [ \begin{matrix}0 & 0 & 0 & 1 & 0 & 1 \\ 1 & 0 & 0 & 0 & 0 & 0 \\ 0 & 1 & 0 & 0 & 0 & 0 \\ 0 & 0 & 1 & 0 & 0 & 0 \\ 0 & 0 & 0 & 1 & 0 & 0 \\ 0 & 0 & 0 & 0 & 1 & 0\end{matrix} ]$$

A Laplacian matrix of the system is as follows:

$$L = [ \begin{matrix}2 & 0 & 0 & - 1 & 0 & - 1 \\ - 1 & 1 & 0 & 0 & 0 & 0 \\ 0 & - 1 & 1 & 0 & 0 & 0 \\ 0 & 0 & - 1 & 1 & 0 & 0 \\ 0 & 0 & 0 & - 1 & 1 & 0 \\ 0 & 0 & 0 & 0 & - 1 & 1\end{matrix} ]$$

An initial state value of the system is as follows:

x(0)=[3,4,7,6,5,5]^{T}.

The following is obtained by using the principle of a mirror graph:

$$L = [ \begin{matrix}2 & - 1 & 0 & - 0.5 & 0 & - 0.5 \\ - 1 & 2 & - 1 & 0 & 0 & 0 \\ 0 & - 1 & 2 & - 1 & 0 & 0 \\ 0 & 0 & - 1 & 2 & - 0.5 & - 0.5 \\ 0 & 0 & 0 & - 0.5 & 1 & - 0.5 \\ - 0.5 & 0 & 0 & 0 & - 0.5 & 1\end{matrix} ] .$$

The solution is performed by means of the control protocol of the present invention, and finally sufficient and necessary conditions that the system can achieve average consensus are obtained:

$$τ < \frac{1}{{λ}_{max}} , 0 < p < \frac{2}{{λ}_{max}} + 2 τ$$

Where λᵢ is an eigenvalue of the Laplacian matrix L̅. It can be seen that the value of time delay τ depends on the eigenvalue of the Laplacian matrix L̅ of the mirror graph, and the value of sampling period p is not only related to the eigenvalue of the Laplacian matrix L̅ of the mirror graph, but also related to the value of the time delay. Because the maximum eigenvalue λₘₐₓ of the Laplacian matrix L̅ is 3.8229, the upper limit of time delay is calculated to be 0.2616 according to the sufficient and necessary conditions to achieve average consensus, and the upper limit of sampling period p is further calculated according to the actual value of time delay τ.

FIG. 3 is an example where the time delay constraint condition is satisfied, but the period constraint condition is not satisfied. If the value of time delay τ is 0.2, the upper limit of sampling period p is 0.9232 by further calculation according to

$$p < \frac{2}{{λ}_{max}} + 2 τ .$$

The value of p is 0.93, which exceeds the upper limit. The convergence state value of each agent is shown in FIG. 3. It can be seen that if the time delay satisfies the constraint condition, but the sampling period does not satisfy the period constraint condition, the agricultural first-order multi-agent system cannot achieve average consensus.

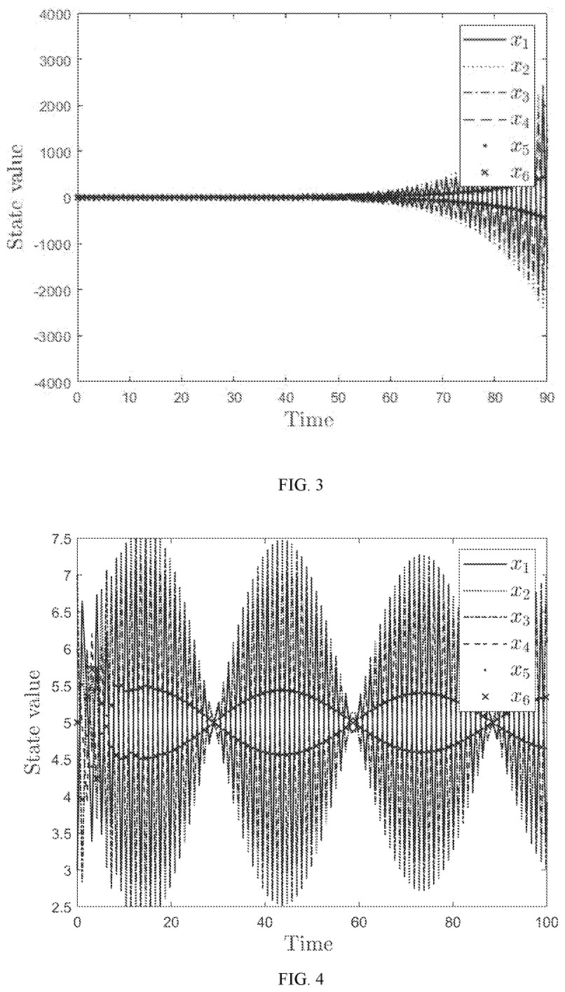

FIG. 4 is an example where the time delay constraint condition is not satisfied, but the period constraint condition corresponding to the time delay is satisfied. It can be known according to the sufficient and necessary conditions of average consensus obtained by the present invention that the upper limit of time delay τ is 0.2616. The current value of time delay is 0.262, which exceeds the upper limit. By further calculation, the upper limit of sampling period p is 1.0472, and the value of p is 1.04. The convergence state value of each agent is shown in FIG. 4. It can be seen that if the time delay does not satisfy the constraint condition, but the sampling period satisfies the period constraint condition, the agricultural first-order multi-agent system cannot achieve average consensus.

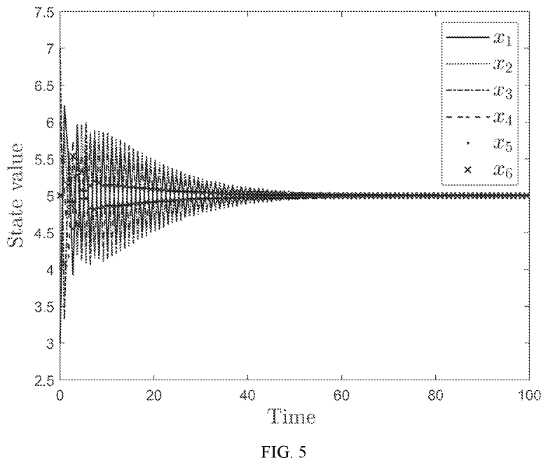

FIG. 5 is an example where both the time delay constraint condition and the period constraint condition are satisfied. The value of time delay is 0.2, which is less than the upper limit; and the value of sampling period p is 0.92, which is less than the upper limit 0.9232 of sampling period when the time delay is 0.2. The convergence state value of each agent is shown in FIG. 5. It can be seen that if the time delay satisfies the constraint condition and the sampling period also satisfies the period constraint condition, that is, when the values of τ and p the sufficient and necessary conditions of the control protocol of the present invention, the agricultural first-order multi-agent system can achieve average consensus.

As can be seen from FIG. 3 to FIG. 5, for the agricultural multi-agent system with time delays, the invented distributed control protocol for the average consensus of the agricultural multi-agent system with time delays based on sampled data can effectively achieve average consensus of the system.

Although the specific embodiments of the present invention have been shown and described, it could be appreciated by those of ordinary kill in the art that many changes, modification, substitutions and variations may be made to these embodiments without departing from the principle and spirit of the present invention, and the scope of the present invention is defined by the appended claims and equivalents thereof.

What is claimed is:

1. A distributed control method for consensus of an agricultural multi-agent system based on sampled data, comprising the following steps:
step 1, designing a distributed control protocol based on sampled information in a time delay state, for a first-order multi-agent system under fixed directed topology;
step 2, obtaining a dynamic model of the multi-agent system with time delays based on sampled information, and transforming a consensus problem of multiple agents into a stability problem by means of tree transformation;
step 3, determining constraint conditions on a time delay and a sampling period that the multi-agent system achieves stability, that is, sufficient and necessary conditions that the agents in the multi-agent system achieve average state consensus; and
step 4, realizing average consensus of the multi-agent system according to the sufficient and necessary conditions that the multi-agent system achieves average consensus; wherein
in step 1, for a system including N agents, states of the agents are represented by xᵢ, where i=1, 2, . . . , N; a communication topology directed graph G=(V, E, A) of a networked multi-agent system is a weighted directed graph, N vertices v in the directed graph G represent N agents in the multi-agent system, and a i-th vertex of the directed graph G is represented by vᵢ, where i=1, 2, . . . , N; V={v₁, v₂, . . . , v_{N}} represents a set of vertices, and the vertex vᵢ is the i-th vertex in the directed graph G and corresponds to a i-th agent in the multi-agent system; there are totally N vertices, each agent is a vertex of the directed graph G, and a state level of each vertex represents an actual physical value, including position, temperature, or voltage; E⊆V×V is a frontier set, and A=[aᵢⱼ] is a non-negative weighted adjacency matrix, where j=1, 2, . . . , N; a directed edge from the vertex vᵢ to vⱼ is Eᵢⱼ=(vⱼ, vᵢ), an adjacency matrix element aᵢⱼ with regard to Eᵢⱼ is a non-negative real number, and a set of neighborhood nodes of the vertex vᵢ is Nᵢ={vᵢ∈V|(vⱼ,vᵢ)∈E}; when there is at least one directed edge between two vertices, the directed graph G is set as a strongly connected graph, and the directed graph G has an indegree matrix
$$Δ = diag \{ {\sum }_{j = 1}^{n} {a}_{1 j} , {\sum }_{j = 1}^{n} {a}_{2 j} , … , {\sum }_{j = 1}^{n} {a}_{nj} \}$$
and a Laplacian matrix L=[lᵢⱼ]∈R^{n×n}, where L=Δ−A; an element lᵢⱼ in the Laplacian matrix satisfies
$${l}_{ij} = \{ \begin{matrix}{\sum }_{j ∈ N ( i )} {a}_{ij} , j = i \\ - {a}_{ij} , j \neq i\end{matrix} ;$$
for a strongly connected agricultural multi-agent system, a diagonal matrix is W=diag{det(L₁₁), det(L₂₂), . . . , det(Lₙₙ)}, and a left eigenvector is wᵢ=[det(L₁₁) det(L₂₂), . . . , det(Lₙₙ)], where ω^{T} L=0ₙ^{T}, Lᵢᵢ∈R⁽ⁿ⁻¹⁾⁽ⁿ⁻¹⁾ is a matrix after the i-th row and the i-column are removed from the Laplacian matrix, where det(Lᵢᵢ) represents a determinant of the matrix Lᵢᵢ; a new topology graph G̅=(V, Ē, Ā) may be obtained according to the diagonal matrix W, where an element āᵢⱼ in Ā=[āᵢⱼ] satisfies the following:
$${\overline{a}}_{ij} = \frac{det ( {L}_{ii} ) {a}_{ij} + det ( {L}_{jj} ) {a}_{ji}}{2} , ∀ i , j ∈ {ℐ}_{n} ;$$
where [symbol] ₙ={1, 2, . . . , N}, the following may be obtained after putting [āᵢⱼ] into:
$$\overline{A} = \frac{WA + {A}^{T} W}{2} ;$$
a relationship between the Laplacian matrix L of the topology graph G and the Laplacian matrix L̅ of the topology graph G̅ is as follows:
$$\overline{L} = \frac{WA + {L}^{T} W}{2} ;$$
in the directed graph G of the multi-agent system, the state of each vertex vᵢ is represented by xᵢ, a state vector of vertices is represented by x(t)=[x₁(t), x₂(t), . . . , xₙ(t)]^{T}∈Rⁿ, and the dynamic model of the first-order multi-agent system with fixed directed topology is represented as follows:
\dot{x}ᵢ(t)=uᵢ(t),∀i∈ [symbol] ₙ,
where uᵢ(t) is a control input used for solving a consensus problem;
for a communication delay of the agricultural multi-agent system, a sampling period is set as p; considering an existence of a time delay τ shorter than one sampling period, a proposed distributed delay control protocol based on sampled data is as follows:
$${u}_{i} ( t ) = \{ \begin{matrix}{\sum }_{j ∈ N ( i )} {\overline{a}}_{ij} ( {x}_{j} ( kp - p ) - {x}_{i} ( kp - p ) ) , t ∈ [ kp , kp + τ ] \\ {\sum }_{j ∈ N ( i )} {\overline{a}}_{ij} ( {x}_{j} ( kp ) - {x}_{i} ( kp ) ) , t ∈ [ kp + τ , kp + p ]\end{matrix} , where$$
$$∀ i ∈ {ℐ}_{n} , k = 0 , 1 , 2 , … , 0 < τ < p .$$

2. The distributed control method for consensus of an agricultural multi-agent system based on sampled data according to claim 1, wherein
in step 2, a specific process of obtaining a dynamic model of the multi-agent system with time delays by means of the distributed control protocol based on sampled data, and transforming a consensus problem of multiple agents into a stability problem by means of tree transformation comprises:
obtaining, according to a proposed distributed delay control protocol, the dynamic model of the first-order multi-agent system at the sampling period p and time delay τ:
$$[ \begin{matrix}x ( kp + p ) \\ x ( kp )\end{matrix} ] = ϕ [ \begin{matrix}x ( kp ) \\ x ( kp - p )\end{matrix} ] ,$$
$$k = 0 , 1 , 2 , …$$
$$where$$
$$ϕ = [ \begin{matrix}{I}_{n} - ( p - τ ) \overline{L} & - τ \overline{L} \\ {I}_{n} & 0\end{matrix} ] ,$$
where I is a unit matrix, and Iₙ is an n-order unit matrix.

3. The distributed control method for consensus of an agricultural multi-agent system based on sampled data according to claim 2, wherein
in order to analyze a convergence problem of the system after the protocol is used, the dynamic model is transformed by means of tree transformation:
$$\begin{matrix}{y}_{1} ( kp ) = {x}_{1} ( kp ) \\ {y}_{2} ( kp ) = {x}_{1} ( kp ) - {x}_{2} ( kp ) \\ {y}_{3} ( kp ) = {x}_{1} ( kp ) - {x}_{3} ( kp ) \\ ⋮ \\ {y}_{n} ( kp ) = {x}_{1} ( kp ) - {x}_{n} ( xp ) ;\end{matrix}$$
an invertible matrix Q is obtained:
$$Q = [ \begin{matrix}1 & 0 & 0 & ⋯ & 0 \\ 1 & - 1 & 0 & ⋯ & 0 \\ 1 & 0 & - 1 & ⋯ & 0 \\ ⋮ & ⋮ & ⋮ & ⋱ & ⋮ \\ 1 & 0 & 0 & ⋯ & - 1\end{matrix} ] = [ \begin{matrix}C ∈ {R}^{1 \times n} \\ E ∈ {R}^{( n - 1 ) \times n}\end{matrix} ] ;$$
Q⁻¹ is obtained:
$${Q}^{- 1} = [ \begin{matrix}1 & 0 & 0 & ⋯ & 0 \\ 1 & - 1 & 0 & ⋯ & 0 \\ 1 & 0 & - 1 & ⋯ & 0 \\ ⋮ & ⋮ & ⋮ & ⋱ & ⋮ \\ 1 & 0 & 0 & ⋯ & - 1\end{matrix} ] = [ \begin{matrix}w , ∈ {R}^{n \times 1} & F ∈ {R}^{n \times ( n - 1 )}\end{matrix} ] ;$$
the following is obtained from Q and Q⁻¹:
$$y ( kp ) {=}^{△} [ \begin{matrix}{y}_{1} ( kp ) \\ {y}_{2} ( kp ) \\ ⋮ \\ {y}_{n} ( kp )\end{matrix} ] = Qx ( kp ) ;$$
thus, y(kp+p)=Qx(kp+p), y(kp−p)=Qx(kp−p) and y(kp)=Qx(kp) are obtained, and the following is further obtained:
$$[ \begin{matrix}y ( kp + p ) \\ y ( kp )\end{matrix} ] = [ \begin{matrix}{I}_{n} - ( p - τ ) H & - τ H \\ {I}_{n} & {0}_{n}\end{matrix} ] [ \begin{matrix}y ( kp ) \\ y ( kp - p )\end{matrix} ] ,$$
$$where$$
$$H = Q \overline{L} {Q}^{- 1} = [ \begin{matrix}0 & C \overline{L} F \\ {0}_{n - 1} & E \overline{L} F\end{matrix} ] ;$$
thus, the system is divided into two subsystems:
$$[ \begin{matrix}{y}_{1} ( kp + p ) \\ {y}_{1} ( kp )\end{matrix} ] = [ \begin{matrix}1 & 0 \\ 1 & 0\end{matrix} ] [ \begin{matrix}{y}_{1} ( kp ) \\ {y}_{1} ( kp - p )\end{matrix} ] - [ \begin{matrix}( p - τ ) C \overline{L} F & τ C \overline{L} F \\ 0 & 0\end{matrix} ] [ \begin{matrix}\hat{y} ( kp ) \\ \hat{y} ( kp - p )\end{matrix} ]$$
$$and$$
$$[ \begin{matrix}{y}_{1} ( kp + p ) \\ {y}_{1} ( kp )\end{matrix} ] = [ \begin{matrix}{I}_{n - 1} - ( p - τ ) E \overline{L} F & - τ E \overline{L} F \\ {I}_{n - 1} & {0}_{n - 1}\end{matrix} ] [ \begin{matrix}\hat{y} ( kp + p ) \\ \hat{y} ( kp - p )\end{matrix} ] ,$$
where
ŷ(kp)=[y₂(kp),y₃(kp), . . . ,yₙ(kp)]^{T} and
ŷ(kp−p)=[y₂(kp−p),y₃(kp−p), . . . ,yₙ(kp−p)]^{T};

4. The distributed control method for consensus of an agricultural multi-agent system based on sampled data according to claim 3, wherein
in step 3, the constraint conditions on the time delay and the sampling period that the multi-agent system achieves stability, that is, the sufficient and necessary conditions that the agents in the multi-agent system achieve average state consensus, are obtained by means of bilinearity and Hurwitz stability criteria, specifically:
the following is obtained by using an invertible matrix T:
$${T}^{- 1} E \overline{L} FT = Λ = [ \begin{matrix}{λ}_{2} & * & & \\ & {λ}_{3} & ⋱ & \\ & & ⋱ & * \\ & & & {λ}_{n}\end{matrix} ] ,$$
where λ₂, λ₃, . . . , λₙ are non-zero eigenvalues of L̅ and elements, * is 0 or 1, and further,
\tilde{y}(kp+p)=T⁻¹ŷ(kp+p)
\tilde{y}(kp)=T⁻¹ŷ(kp)
\tilde{y}(kp−p)=T⁻¹ŷ(kp−p);
a dimension reduction system is transformed into:
$$[ \begin{matrix}\tilde{y} ( kp + p ) \\ \tilde{y} ( kp )\end{matrix} ] = ζ [ \begin{matrix}\tilde{y} ( kp + p ) \\ \tilde{y} ( kp - p )\end{matrix} ] ,$$
$$where$$
$$ζ = [ \begin{matrix}{I}_{n - 1} - ( p - τ ) Λ & - τΛ \\ {I}_{n - 1} & {0}_{n - 1}\end{matrix} ] .$$
a characteristic polynomial of ζ is further obtained:
$$det ( {sI}_{2 n - 2} - ζ ) = \vert \begin{matrix}{sI}_{n - 1} - [ {I}_{n - 1} - ( p - τ ) Λ ] & τΛ \\ - {I}_{n - 1} & {sI}_{n - 1}\end{matrix} \vert = \vert ξ \vert ;$$
the following is obtained from the properties of a block matrix:
$$\vert ξ \vert = \vert {sI}_{n - 1} \vert \vert {sI}_{n - 1} - [ {I}_{n - 1} - ( p - τ ) Λ ] + {{I}_{n - 1} ( {sI}_{n - 1} )}^{- 1} τΛ \vert = {\prod }_{i = 2}^{n} [ {s}^{2} - ( 1 - {pλ}_{l} + {τλ}_{l} ) s + {τλ}_{l} ] = {\prod }_{i = 2}^{n} {g}_{i} ( s ) ;$$
then, the following can be known by bilinear transformation of
$$s = \frac{z + 1}{z - 1} :$$
fᵢ(z)=pλᵢz²+2(1−τλᵢ)z+(p−2τ)λᵢ+2.

5. The distributed control method for consensus of an agricultural multi-agent system based on sampled data according to claim 4, wherein
if fᵢ(z) is Hurwitz-stable and gᵢ(s) is Schur-stable, the stability is determined as follows:
assuming z=ωι, then:
fᵢ(ω)=−pλᵢω²+2(1−τλᵢ)ωι+(p−2τ)λᵢ+2,
its real part is:
f_{ω}(ω)=−pλᵢω²+(p−2τ)λᵢ+2 and
its imaginary part is:
fᵢ(ω)=2(1−τλᵢ)ω;
upon verification, fᵢ(z) is Hurwitz-stable when satisfying the following conditions:
$$τ < \frac{1}{{λ}_{max}} , 0 < p < \frac{2}{{λ}_{max}} + 2 τ .$$
that is, under the Hurwitz-stable condition, the multi-agent system achieves consensus.

6. The distributed control method for consensus of an agricultural multi-agent system based on sampled data according to claim 5, wherein
step 4 comprises the following steps:
when L̅ has an eigenvalue of 0, determining ϕ to have corresponding determinable eigenvalues of 0 and 1; the condition of Hurwitz stability of the system is determined after the tree transformation; when the constraint conditions are satisfied, the modulus values of remaining unknown eigenvalues of ϕ are less than 1, that is, the eigenvalues of ϕ except 0 and 1 are within a unit circle under the conditions; because G̅ is undirected strongly connected, so a right eigenvector ωᵣ and a left eigenvector ωₗ of ϕ when the eigenvalue is 1 satisfy the following:
$${w}_{r} = {w}_{l} = \frac{1}{\sqrt{n}} {1}_{n} ,$$
and ωₗ^{T} ωᵣ=1 is satisfied;
all other eigenvalues of ϕ are within the unit circle and there is:
$$[ \begin{matrix}x ( kp + p ) \\ x ( kp )\end{matrix} ] = ϕ [ \begin{matrix}x ( kp ) \\ x ( kp - p )\end{matrix} ] = {ϕ}^{k} [ \begin{matrix}x ( 0 ) \\ x ( 0 )\end{matrix} ] ,$$
$$so$$
$${lim}_{k \to ∞} [ \begin{matrix}x ( kp + p ) \\ x ( kp )\end{matrix} ] = [ \begin{matrix}{w}_{r} {w}_{l}^{T} & 0 \\ {w}_{r} {w}_{l}^{T} & 0\end{matrix} ] [ \begin{matrix}x ( 0 ) \\ x ( 0 )\end{matrix} ] = [ \begin{matrix}\frac{1}{n} {\sum }_{i = 1}^{n} {x}_{i} ( 0 ) \\ \frac{1}{n} {\sum }_{i = 1}^{n} {x}_{i} ( 0 )\end{matrix} ] ,$$
therefore, the agricultural multi-agent system with a first-order dynamic model achieves average consensus despite time delays.
